(19) United States
(12) Patent Application Publication
(10) Pub. No.: US 2005/0121879 A1
(43) Pub. Date: Jun. 9, 2005

(54) Trailer hitch alignment system

(76) Inventor: Roland Lee Smith, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 10/731,780

(22) Filed: Dec. 9, 2003

(51) Int. Cl. B60D 1/00

(52) U.S. Cl. 280/477

(57) ABSTRACT

A system for aligning a trailer hitch of a towing vehicle with a corresponding socket on a trailer includes: (a) a trailer vertical rod assembly mountable on the trailer, the trailer vertical rod assembly including a vertically extendible rod; (b) a stop mountable on the trailer hitch; (c) a rear mirror line tab attachable to a rear view mirror of the towing vehicle; and (d) a rear window line tab attachable to a rear window of the towing vehicle.

### BACKGROUND OF THE INVENTION

1. Technical Field

The present invention relates to a system for aligning a hitch ball of a trailer hitch that is attached to a towing vehicle with a corresponding socket on a trailer to be towed by the vehicle.

2. Background Information

Connecting a towing vehicle to a trailer can be a difficult, tedious, time-consuming, and aggravating task. In order to connect a towing vehicle to a trailer, the driver of the towing vehicle must back the towing vehicle towards the trailer until the hitch ball is directly below the socket. However, the driver cannot see either the hitch ball or the socket while attempting to align them. Therefore, unless the driver has a passenger who can exit the vehicle and verbally guide him or her, the driver must use trial and error. The driver backs the towing vehicle a bit toward the trailer, exits the towing vehicle to observe the alignment of the hitch ball and the socket, and then backs the towing vehicle up again, hoping for a better position. The driver may have to repeat this process several times before the hitch ball and socket are properly aligned. The driver may even have to restart the process several times, depending on luck and how experienced a driver he or she is. Thus, there is a need for a system to assist a driver in aligning a hitch ball of a vehicle with a socket of a trailer, so that the driver need not leave the towing vehicle or rely on another person for guidance.

Many systems for aligning trailer hitches exist. Some include mechanisms that guide the hitch ball underneath the socket once the hitch ball is partially aligned with the socket. Other systems include poles vertically extending from both the hitch ball and the socket that are visible to the driver of the towing vehicle. Different types of mirrors exist that are attachable to the rear of a towing vehicle, so that the driver ostensibly can view the hitch ball and socket in the rear view mirror. More complicated trailer hitch alignment systems employ sensors, light beams, and sound generators. The trailer hitch alignment system according to the present invention includes a guide that is removably attachable to the rear view mirror of the towing vehicle, a guide that is removably attachable to the rear window of the towing vehicle, and a vertically oriented rod extending upward from the top of the hitch socket.

### BRIEF SUMMARY OF THE INVENTION

The present invention is a trailer hitch alignment system for aligning a hitch ball of a towing vehicle with a corresponding socket of a trailer to be towed by the vehicle. The present trailer hitch alignment system includes:
(a) a trailer vertical rod assembly mountable on the trailer, which includes a rod that extends in a vertical direction;
(b) a stop mountable on the trailer hitch;
(c) a rear view mirror line tab attachable to a rear view mirror of the towing vehicle; and
(d) a rear line tab attachable to a rear window of the towing vehicle, or to an inside of a tailgate where the towing vehicle is a truck. Alternatively, a trunk vertical rod assembly that is attachable to a trunk lid of the towing vehicle may be utilized instead of a rear line tab. The trunk rod assembly is preferably removably attachable to a centerline of the trunk lid by means of a magnet in the trunk rod assembly.

The trailer vertical rod assembly preferably includes:
(a) a hollow receiver sleeve with an aperture at an upper end;
(b) a rod removably insertable through the receiver sleeve aperture into the hollow of the receiver sleeve; and
(c) a detachable pin for securing the rod within the receiver sleeve. The rod stands vertically in the receiver sleeve so that it is visible to a driver of the towing vehicle.

When the present trailer hitch alignment system is in use, the driver backs the towing vehicle toward a trailer while aligning: (1) the rear mirror line tab; (2) the rear line tab in the rear window or on the tailgate, or the trunk vertical rod assembly; and (3) the rod. This aligns the hitch ball so that it ends up under the socket. Then when the stop contacts a flange on the trailer hitch socket, the trailer hitch ball and trailer socket are also vertically aligned and ready for connection. The rear mirror line tab may be on the mirror portion of the rear view mirror, or on the mirror adjustment lever below the rear view mirror. The present alignment system may also comprise a receiver sleeve attachment assembly having an inverted U-shaped or L-shaped brace and an attachment arm for mounting the receiver sleeve above the center of the trailer socket.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 shows a side elevational view of a trailer vertical rod assembly and a stop of a trailer hitch alignment system according to the present invention;

FIG. 2 is a side elevational view of a trailer hitch alignment system according to the present invention, shown in use;

FIG. 3 is a top plan view of a trailer hitch alignment system according to the present invention, shown in use;

FIG. 4A is a front elevational view of a stop of a trailer hitch alignment system according to the present invention;

FIG. 4B is a side elevational view of a stop of a trailer hitch alignment system shown in FIG. 4A;

FIG. 5A is a front elevational view of an alternate embodiment of a stop of a trailer hitch alignment system according to the present invention;

FIG. 5B is a side elevational view of an alternate embodiment of a stop of a trailer hitch alignment system shown in FIG. 5A;

FIG. 6 is a front elevational view of a rear mirror line tab of a trailer hitch alignment system according to the present invention, shown attached to a vehicle's rear view mirror;

FIG. 7 is a front elevational view of a rear line tab of a trailer hitch alignment system according to the present invention, shown attached to a vehicle's rear window;

FIG. 8 is an exploded perspective view of a receiver sleeve attachment assembly according to the present invention;

FIG. 9 shows a side elevational view of a trailer vertical rod assembly and a stop of a trailer hitch alignment system according to the present invention;

FIG. 10 is a perspective view of a tailgate line tab of a trailer hitch alignment system according to the present invention, shown attached to a vehicle's tailgate; and

FIG. 11 is a side elevational view of a trunk vertical rod assembly of a trailer hitch alignment system according to the present invention, shown attached to a vehicle's truck lid.

### DETAILED DESCRIPTION OF THE INVENTION

In the following description, like reference characters designate like or corresponding parts throughout the several views. Also, in the following description, it is to be understood that such terms as “front,” “rear,” “within,” and the like are words of convenience and are not to be construed as limiting terms. Referring in more detail to the drawings, the invention will now be described.

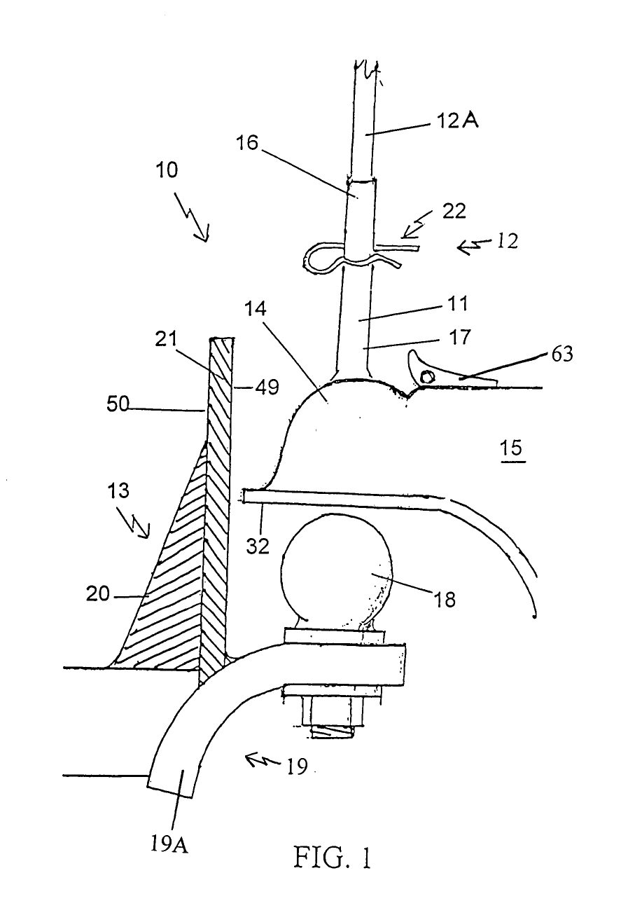

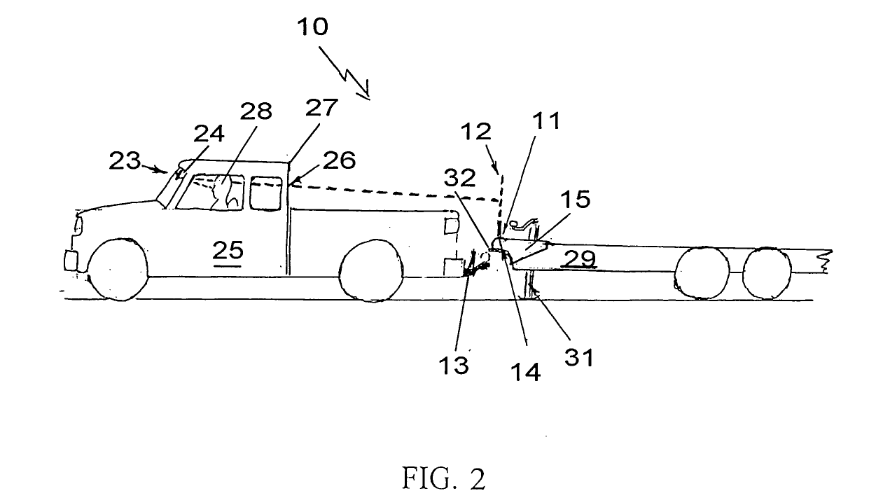

Turning first to FIGS. 1 and 2, a trailer hitch alignment system according to the present invention, generally referred to herein as 10, comprises a stop 13 mountable on a trailer hitch 19 on a vehicle 25, and a trailer vertical rod assembly 12 mountable on a corresponding socket 14 on a tongue 15 of a trailer 29 to be towed by the vehicle 25. In the preferred embodiment depicted in FIG. 1, the trailer vertical rod assembly 12 comprises a receiver sleeve 11 and a removable rod 12A mountable in the receiver sleeve. The receiver sleeve 11 is mountable on a top side of a downwardly facing trailer hitch socket 14. The receiver sleeve 11, which is preferably cylindrical in shape, is centered on the top side of the socket 14, so that the receiver sleeve extends upward in a vertical direction. The receiver sleeve 11 is made of a rigid material such as metal or plastic. It may be welded, bolted, or riveted to the trailer socket 14. Alternatively, a permanent magnet removably attaches the receiver sleeve 11 to the trailer socket 14. The receiver sleeve 11 is hollow with a generally circular aperture at its top end 16 for accommodating the rod 12A. When the rod 12A is in the receiver sleeve 11, a bottom end of the rod preferably contacts a bottom end 17 of the receiver sleeve 11.

The rod 12A of the trailer vertical rod assembly 12 is removably insertable in the aperture of the receiver sleeve 11 such that it extends vertically upward from the receiver sleeve 11, as shown in FIG. 1. The rod 12A is preferably slender, solid, somewhat flexible, and generally cylindrical in shape, and has a diameter approximately equal to the diameter of the aperture in the receiver sleeve 11. The rod 12A is of sufficient length for its upper end to be seen from the rear view mirror 24 of the towing vehicle 25 (see FIG. 2). There is preferably only one rod in the alignment system 10, as only one is necessary.

As illustrated in FIG. 1, the trailer vertical rod assembly preferably further comprises a detachable pin 22, which further secures the rod 12A within the receiver sleeve 11. To remove the rod 12A when the alignment system 10 is not in use, the pin 22, which is preferably generally U-shaped, is removed and the rod is removed and stored until the next use. This is advantageous because the rod 12A is less likely to be broken if it is in storage when the alignment system is not in use.

Also depicted in FIG. 1 is a trailer latching clip 63 for holding the trailer hitch ball 18 in the socket once the coupling process described herein is completed. The trailer usually comes with a latching clip 63 on top of and just in front of the trailer socket 14.

Continuing with FIGS. 1 and 2, the stop 13 is mounted directly behind the hitch ball 18 (i.e., between the towing vehicle and the hitch ball 18) on an upper side of the ball mount 19A of the trailer hitch 19. The trailer hitch 19 is attached to the rear of the towing vehicle 25. The stop 13 may alternatively be permanently mounted on the trailer hitch 19. The stop 13 is preferably mounted on the curved ball mount portion 19A of the trailer hitch 19, as shown in FIG. 1. This placement of the stop is advantageous in that it permits an angled approach to the trailer. Even if the towing vehicle is angled with respect to the trailer, the trailer socket will nevertheless strike the stop when it is mounted on the trailer hitch. If a stop were to instead be mounted on the trailer behind the socket, and the towing vehicle were to approach the trailer at an angle, the hitch ball would likely miss the stop. Thus, the coupling process (of the towing vehicle to the trailer) would not go as smoothly as it does when the present invention is utilized.

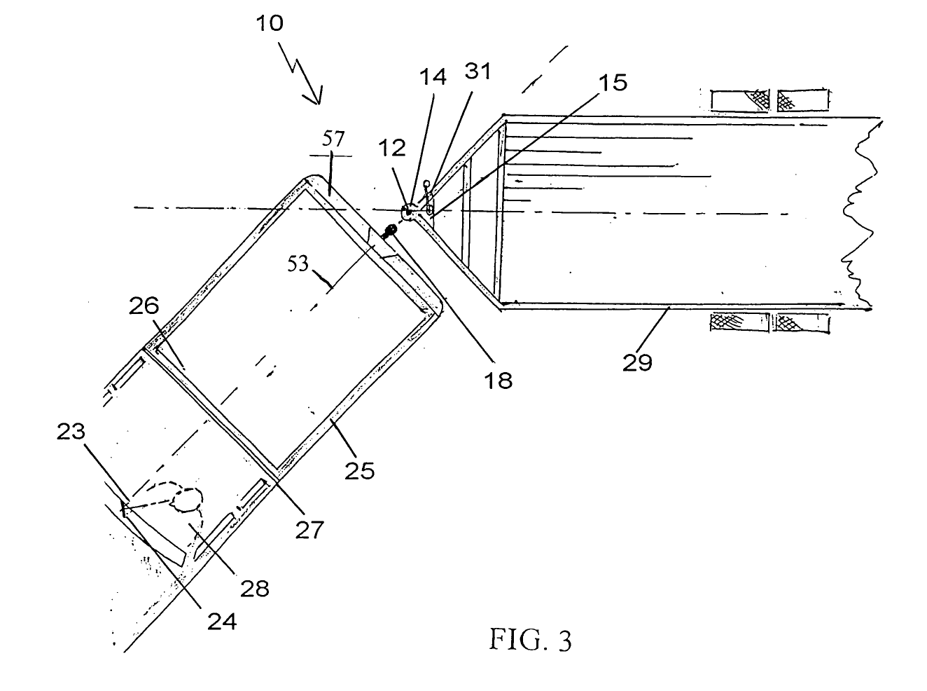

In the preferred embodiment depicted in FIG. 1, the stop 13 comprises a stop brace 20 and a generally planar stop plate 21. The stop brace 20 is generally triangular in shape, when viewed from the side, while the stop plate 21 braced by the brace is generally rectangular in shape. The height of the stop plate 21 is preferably greater than the height of the hitch ball. A longitudinal axis of the stop plate 21 is approximately perpendicular to a longitudinal axis of the towing vehicle 25, so the stop plate is generally parallel to a bumper 57 of the towing vehicle. The longitudinal axis of the towing vehicle 25 is at 53 in FIG. 3. A rear side 49 of the stop plate 21 faces the trailer hitch ball 18, which is behind the vehicle.

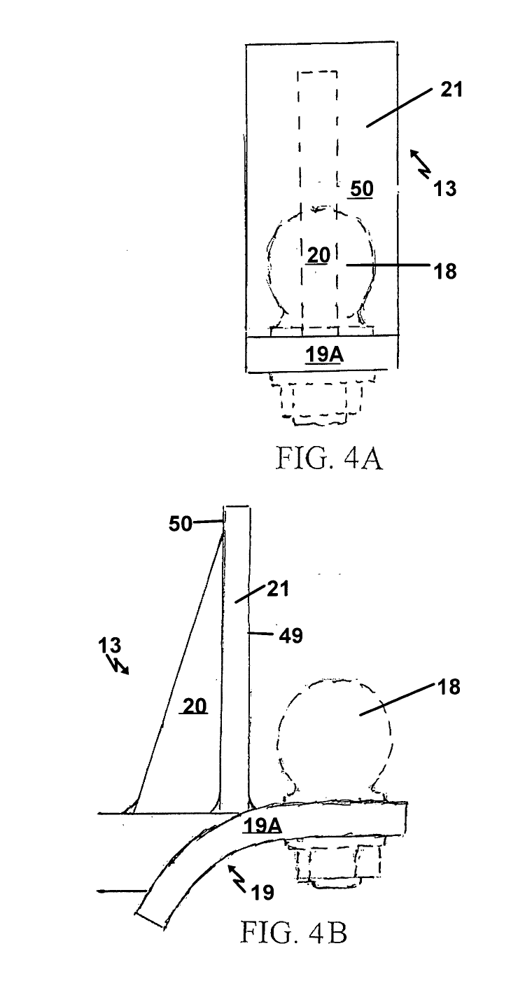

As shown in FIGS. 4A and 4B, the stop brace 20 is attached to a front side 50 of the stop plate 21, which is opposite the rear side 49 of the stop plate 21. A longitudinal axis of the stop brace 20 is preferably perpendicular to a longitudinal axis of the stop plate 21. The lower ends of the stop plate 21 and the stop brace 20 are mounted on the trailer hitch 19, as illustrated in FIG. 1, so they extend upward in a generally vertical direction.

An upper portion of the stop 13 extends vertically above the level of the trailer hitch ball 18, as shown in FIG. 1. The stop plate 21 is taller than the trailer hitch ball 18, so that the stop 13 contacts the flange 32 on the trailer socket 14 when the hitch ball 18 is aligned with the trailer socket 14 (see FIG. 1). The slight jar alerts the driver, who is waiting for the contact, to stop the towing vehicle.

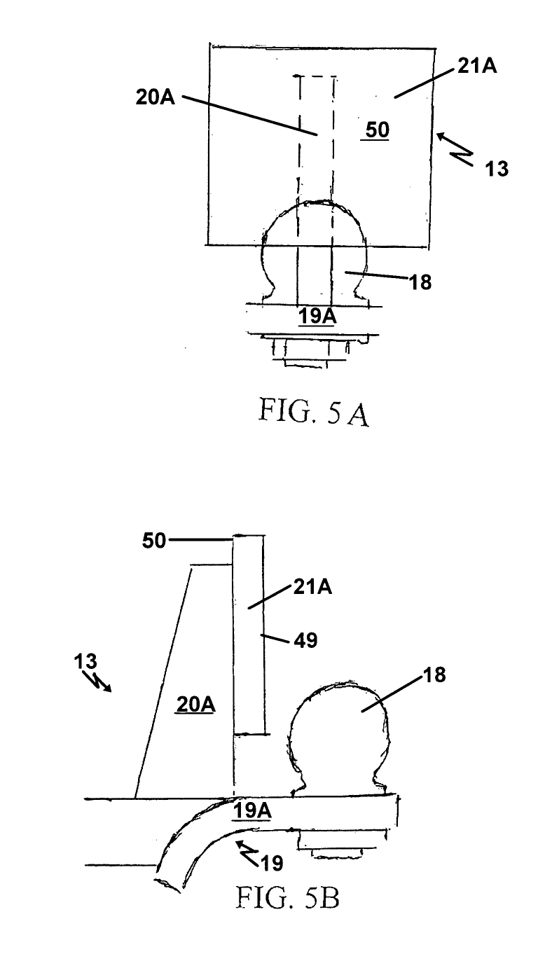

FIGS. 5A and 5B show an alternate embodiment of a stop plate 13A, where an end of the stop brace 20A, but not the stop plate 21A, is mountable on the trailer hitch 19. In FIGS. 5A and 5B, the generally rectangular-shaped stop plate 21A is mounted on the generally rectangular-shaped stop brace 20A. The stop plate 21A preferably has a width that approximately matches the distance from the top of the hitch ball 18 to the top of the trailer socket 14, so that the stop plate strikes the trailer socket flange 32 once the towing vehicle has been backed up a sufficient distance for the hitch ball to be in position under the trailer socket. This contact signals the driver to stop the vehicle immediately.

Alternate means of attaching the stop 13 to the trailer hitch 19 are suitable for use herein. In one embodiment, the stop 13 is bolted to the trailer hitch 19. In an alternate embodiment, a permanent magnet attaches the stop 13 to the trailer hitch 19. Alternatively, the stop 13 is permanently attached to the trailer hitch 19. The stop 13 may be riveted, bolted, or welded to the trailer hitch 19.

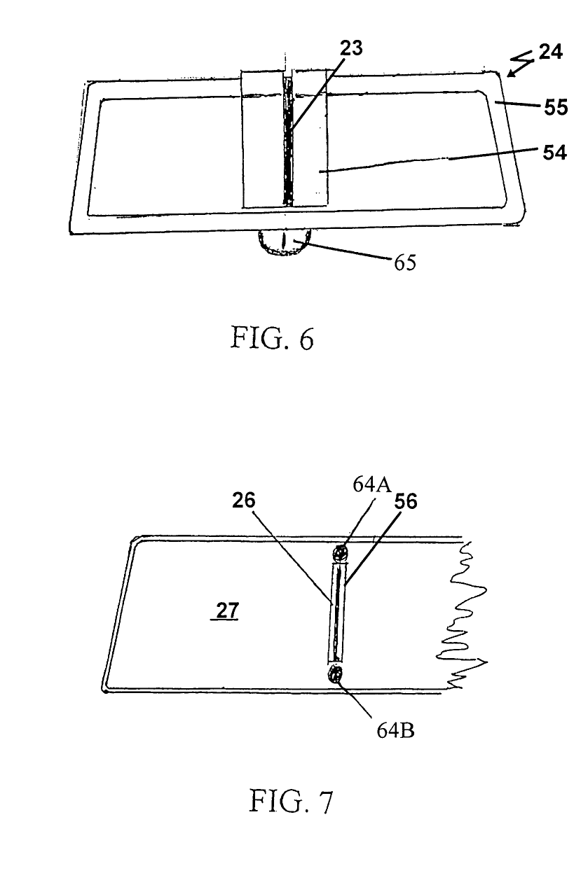

As shown in FIGS. 2, 6, and 7, the trailer hitch alignment system 10 further comprises at least two tabs, preferably a planar rear view mirror line tab 23 and a planar rear line tab 26. The tabs 23, 26 are preferably made of a thin plastic material that removably adheres to mirror and car window glass. The rear view mirror line tab 23 is removably attachable to the rear view mirror 24 of the towing vehicle 25, and the rear line tab 26 is removably attachable to a rear window 27 of the towing vehicle 25. The rear line tab 26 is attached to either the inside or the outside of the rear window 27. In use, the rear view mirror line tab 23 and the rear line tab 26 are attached to the center of the rear view mirror 24 and the rear window 27, so that the rear view mirror line tab 23 and the rear line tab 26 are horizontally aligned with the trailer hitch ball 18, which is centered in the rear of the vehicle. Additionally, the rear view mirror line tab 23 is vertically oriented on the center of the rear view mirror 24 and the rear line tab 26 is vertically oriented on the center of the vehicle's rear window 27, as shown in FIGS. 6 and 7.

Both the rear view mirror line tab 23 and the rear line tab 26 comprise an adhesive on their bottom faces, so that the line tabs 23, 26 can be removably attached to the rear view mirror 24 and the rear window 27, respectively. In an alternate embodiment, a suction cup is attached to the bottom face of the rear view mirror line tab 23 for removably attaching the rear mirror line tab 23 to the rear view mirror 24. In another alternate embodiment, first and second suction cups 64A, 64B at opposite ends of the rear line tab 26 allow removable attachment of the rear line tab 26 to the rear window 27, as shown in FIG. 7, or to a front face of a tailgate where the towing vehicle is a pick-up truck. In still another alternate embodiment, the rear view mirror line tab 23 removably snaps onto the rear view mirror light deflection lever 65.

Referring to FIGS. 6 and 7, in yet another embodiment, the rear mirror line tab 23 is incorporated into (e.g., printed on) a first sheet of transparent plastic 54 or the like, which is preferably the size of and insertable in and attachable to the rear view mirror portion 24 within the rear view mirror frame 55 (see FIG. 6). Alternatively, a rear mirror line tab 23 may be placed on the rear view mirror light deflection lever 65 directly below the rear view mirror portion 24 (see FIG. 6). As shown in FIG. 7, the rear window line tab 26 is incorporated into (e.g., printed on) a second sheet of transparent plastic 56, most preferably an 8½ by 11 inch sheet. The second transparent sheet 56 is insertable in and removably attachable to the vehicle's rear window 27. The first and second transparent sheets 54, 56 are removably attachable to the rear view mirror 24 and the rear window 27 by virtue of static electricity. Alternatively, the bottom faces of the first and second transparent sheets 54, 56 are coated with adhesive, so that the transparent sheets 54, 56 removably adhere to the rear view mirror 24 and the rear window 27, respectively. In another alternative embodiment, suction cups 64 attached to the bottom face of the second transparent sheet 56 removably secure the second transparent sheet 56 to the rear window 27. Preferably, the line tabs 23, 26 are brightly colored (e.g., fluorescent), so that they are clearly visible to a driver 28 of the towing vehicle 25. Most preferably, the line tabs 23, 26 are reflective so that they are clearly visible to the driver 28 of the towing vehicle 25 at night.

Prior to using the alignment system 10, the receiver sleeve 11 must be attached to the socket 14 on the tongue 15 of the trailer 29, the rod 12A must be secured within the receiver sleeve 11, and the level of the trailer socket 14 must be above the level of the trailer hitch ball 18 (see FIG. 1). If the trailer hitch ball 18 is not lower than the trailer socket 14, the driver 28 can use a jack 31 to elevate the trailer 29 to an appropriate level.

Once the alignment system 10 is in place on the towing vehicle and the trailer, the driver 28 backs the towing vehicle 25 toward the trailer 29 while assuring that the rear view mirror line tab 23, the rear line tab 26, and the rod 12A are aligned (i.e., on top of one another). The driver's line of sight is indicated by the dashed lines in FIG. 2. If one of the three moves out of alignment, the driver 28 slows the vehicle 25 and steers it into a position where the three are again aligned. When the rear mirror line tab 23, rear window line tab 26, and rod 12A are aligned, the trailer hitch ball 18 and the trailer socket 14 are horizontally aligned. The driver 28 continues slowly backing the towing vehicle 25 toward the trailer 29 until the stop 13 contacts a flange 32 on the socket 14, which indicates that the trailer hitch ball 18 and the trailer socket 14 are vertically aligned. The driver 28 quickly stops the vehicle 25, exits the vehicle, and lowers the trailer socket 14 onto the trailer hitch ball 18, normally using a jack 31, as shown in FIG. 2. Once the connection is complete, the trailer 29 can be towed to the desired location.

With the present alignment system 10, the trailer socket 14 may be approached from an odd angle, as shown in FIG. 3. Even though the vehicle 25 depicted in FIG. 3 is approaching the trailer 29 at approximately a 135 degree angle with respect to the trailer, horizontal alignment of the rear mirror line tab 23, the rear window line tab 26, and the rod 12A results in the horizontal alignment of the hitch ball 18 and the trailer socket 14. The driver 28 need not repeatedly exit the vehicle 25 to determine his or her progress.

receiver sleeve attachment assembly for removably mounting the receiver sleeve to the trailer socket.

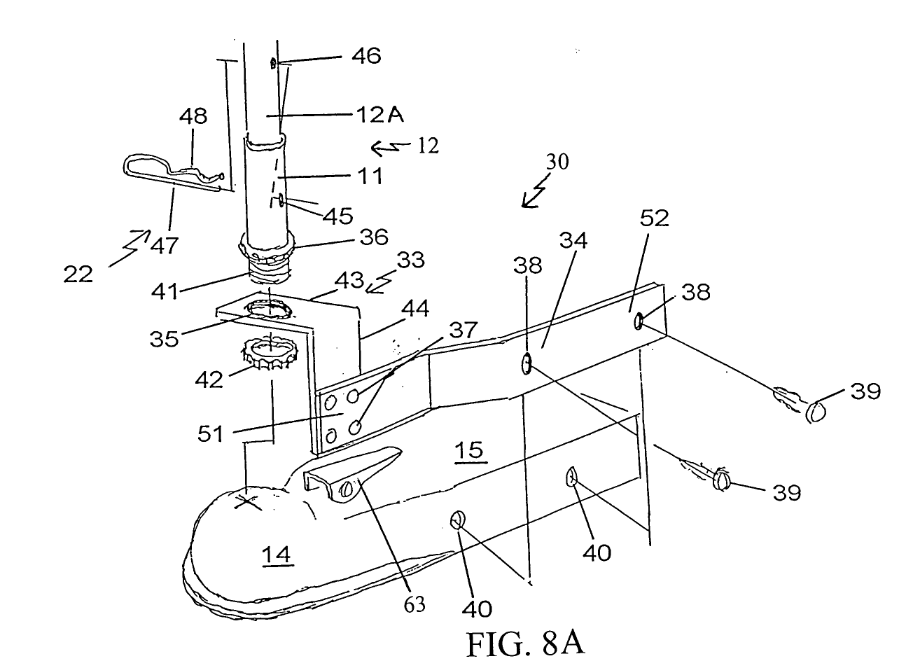

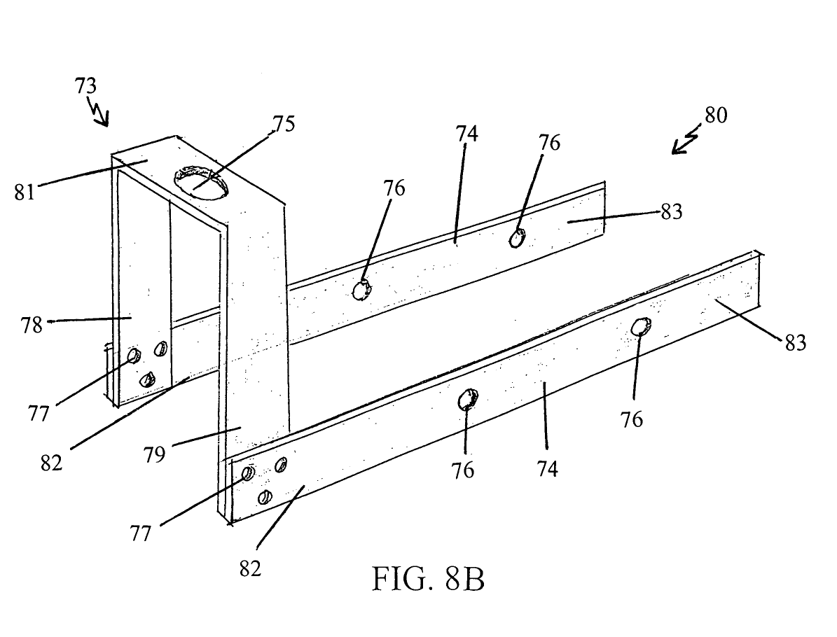

Looking at FIG. 8A, a receiver sleeve attachment assembly 30 for removably mounting the receiver sleeve 11 above the center of the top side of the socket 14 comprises a generally L-shaped section 33A and an attachment arm 34. The attachment arm 34 is generally rectangular in shape. The L-shaped section 33 has a horizontal portion 43 and a vertical portion 44. As shown in FIG. 8A, the vertical portion 44 of the L-shaped section 33 is attached to the first end 51 of the attachment arm 34, preferably by bolts or first rivets 37 extending through the L-shaped section 33 and the attachment arm 34. A second end 52 of the attachment arm 34 is attachable to the trailer tongue 15.

In the preferred embodiment shown in FIG. 8A, the attachment arm 34 comprises generally circular, spaced apart, first holes 38 in a second end 52 of the attachment arm 34 opposite to the L-shaped section 33. The receiver sleeve attachment assembly 30 is connected to the trailer tongue 15 by bolts 39 extending through first holes 38 in the attachment arm 34 and generally circular, corresponding second holes 40 in a side of the trailer tongue 15. Furthermore, the horizontal portion 43 of the L-shaped section 33 comprises a generally circular, threaded, horizontal portion hole 35 that is larger than the first and second holes 38, 40. The receiver sleeve 11 has a threaded end 41, whose threads complement the threads of the horizontal portion hole 35 in the L-shaped section, which is insertable in the horizontal portion hole for coupling with the receiver sleeve attachment assembly 30.

Continuing with FIG. 8A, a first, threaded nut 36 placed over the threaded section 41 abuts a top side of the horizontal portion 43 of the L-shaped section 33. A second, threaded nut 42 placed over the threaded section 41 after the threaded end 41 is screwed into the third hole 35 abuts a bottom side of the horizontal portion 43 of the L-shaped section 33. The nuts 36, 42 further secure the receiver sleeve 11 to the receiver sleeve attachment assembly 30.

Alternatively, the receiver sleeve 11 is mounted directly on the center of the top side of the trailer socket 14. In one embodiment, the receiver sleeve 11 is bolted to the socket 14. In another embodiment, a permanent magnet removably attaches the receiver sleeve 11 to the trailer socket 14. The receiver sleeve 11 may also be permanently mounted to the socket 14. For example, the receiver sleeve 11 may be welded or riveted to the socket 14.

FIG. 8A also shows the interaction of the pin 22, which is generally U-shaped, with the receiver sleeve 11 and the rod 12A. The pin 22 comprises a linear pin section 47 continuous at one end with and opposite to a curved pin section 48. The linear pin section 47 is insertable in a generally circular fourth hole 45 extending transversely through the receiver sleeve 11, and a generally circular fifth hole 46 extending transversely through the rod 12A. When the pin 22 is in place, the curved pin section 48 contacts the outside of the receiver sleeve 11.

Turning to FIG. 8B, an alternative, yoke-shaped receiver sleeve attachment assembly 80 is also for removably mounting the receiver sleeve 11 above the center of the top side of the socket 14. This yoke-shaped attachment assembly 80 comprises a generally inverted U-shaped section 73 and matching arms 74 for attaching the section to the trailer. The matching arms 74 are shaped to fit the configuration of the trailer. Second rivets 77 attach a first, bottom end 78 and a second, bottom end 79 of the U-shaped section 73 to third ends 82 of the matching arms 74. A substantially horizontal section 81 of the U-shaped section 73 comprises a generally circular, threaded receiver sleeve hole 75 for receiving the threaded end 41 of the receiver sleeve 11. Bolts 39 extending through second holes 40 and generally circular, sixth holes 76 in the fourth ends 83 of the matching arms 74 connect the matching arms 74 to the trailer tongue 15.

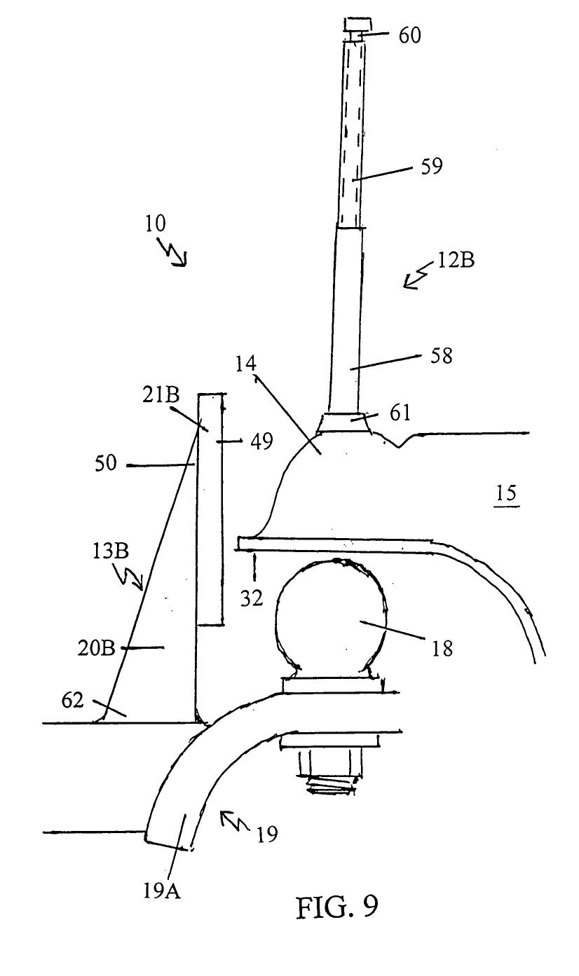

In an alternate embodiment shown in FIG. 9, a trailer vertical rod assembly 12 comprises a telescoping rod 12B comprised of three successively thinner segments, which telescope into one another. This is advantageous in that a collapsed rod is less likely to present an enticement to vandals. This telescoping rod 12B is extendible in a vertical direction. When the alignment system of the present invention is not in use, an uppermost rod segment 60 (with a stop at its upper end) telescopes into a middle rod segment 59, and both of those segments 60, 59 telescope into a lower rod segment 58.

The lower end of the telescoping rod 12B may be stationary and affixed to the upper surface of the trailer tongue at its center, or the lower end may comprises a pivoting mechanism 61. In the latter case, the lower rod segment 58 is pivotable around the pivoting mechanism 61, so that the lower rod segment can be rotated ninety degrees from its vertical in-use position to a nearly horizontal, inclined position along the upper edge of the trailer. When it is not in use, the rod 12B is less likely to be broken when it is in an inclined position, or when it has been removed.

Continuing with FIG. 9, another embodiment of the stop 13B is comprised of a stop brace 20B affixed to a front side 50 of a stop plate 21B. The lower end of the stop brace 20B, but not the stop plate, is affixed by a permanent magnet 62 to an upper surface of a trailer hitch 19.

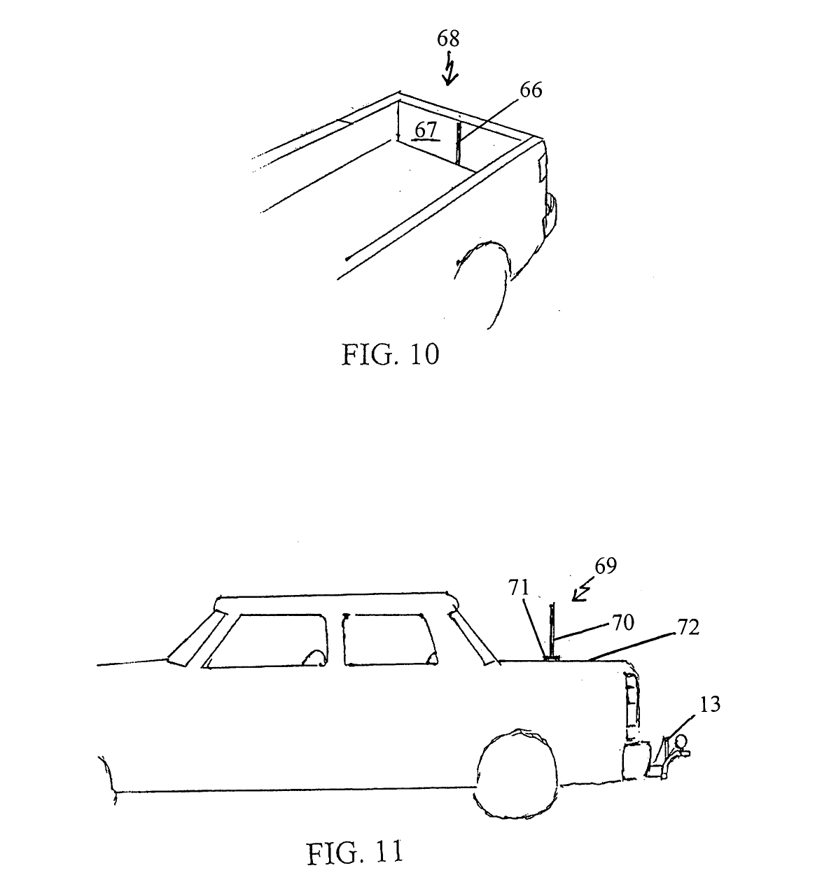

Referring to FIG. 10, a tailgate line tab 66 may be substituted for the rear window line tab 26. The tailgate line tab 66 is removably attachable to an inside, front face 67 of a towing vehicle's tailgate 68, where the towing vehicle has a tailgate (e.g., a pickup truck). The bottom face of the tailgate line tab 66 is preferably coated with an adhesive so that the tailgate line tab 66 removably adheres to the inside face of the tailgate 68. Alternatively, at least one permanent magnet affixed to a bottom face of the tailgate line tab 66 removably adheres the tailgate line tab 66 to the tailgate 68.

To use a trailer hitch alignment system according to the present invention including the rear view mirror line tab 23 depicted in FIG. 6, the tailgate line tab 66 of FIG. 10, and the stop 13 and trailer vertical rod assembly 12 shown in FIG. 9 (or FIG. 1), the alignment system is first set up on the towing vehicle and the trailer. The driver 28 then backs the towing vehicle 25 toward the trailer 29 while assuring that the rear view mirror line tab 23, the tailgate line tab 66, and the rod 12A of the trailer vertical rod assembly 12 are aligned. Once the towing vehicle has been backed up a sufficient distance for the hitch ball 18 to be in position under the trailer socket 14, the stop plate 21 strikes the trailer socket flange 32. This contact signals the driver to stop the towing vehicle immediately. The hitch ball 18 is now aligned under the trailer socket 14. The driver puts the towing vehicle in “Park”, and exits the vehicle. The driver then lowers the trailer socket 14 onto the hitch ball 18 and engages the trailer latching clip 63 (see FIG. 1), as usual.

As depicted in FIG. 11, an alternate embodiment of an alignment system according to the present invention includes a trunk vertical rod assembly 69 in place of a rear line tab 26 in a rear window 27 of the towing vehicle, or a tailgate line tab 66 on the towing vehicle's tailgate. The trunk vertical rod assembly 69 comprises a second rod 70, which is attached at one end to, and extends vertically from, a center of a generally horizontal, circular base 71. The length of the second rod is most preferably approximately equal to the height of the rear window. The trunk vertical rod assembly 69 is removably attachable to the top of a vehicle's trunk lid 72, where the towing vehicle 25 has a trunk lid 72. Preferably, at least one permanent magnet affixed to a bottom face of the base 71 allows the trunk vertical rod assembly 69 to be removably adhered to the trunk lid 72. The user preferably makes a mark at the outset with a permanent marker at the center of the trunk lid to assist in rapid placement of the trunk vertical rod assembly 69 during subsequent uses of the trailer hitch alignment system. Alternatively, the bottom face of the base 71 may be coated with an adhesive, so that the trunk vertical rod assembly 69 adheres to the trunk lid 72.

To use a trailer hitch alignment system according to the present invention including the rear view mirror line tab 23 depicted in FIG. 6, the trunk vertical rod assembly 69 in FIG. 11, and the stop 13 and trailer vertical rod assembly 12 shown in FIG. 9 (or FIG. 1), the alignment system is first set up on the towing vehicle and the trailer. The driver 28 then backs the towing vehicle 25 toward the trailer 29 while assuring that the rear view mirror line tab 23, the second rod 70 of the trunk vertical rod assembly 69, and the rod 12A of the trailer vertical rod assembly 12 are aligned. Once the towing vehicle has been backed up a sufficient distance for the hitch ball 18 to be in position under the trailer socket 14, the stop plate 21 strikes the trailer socket flange 32. This contact signals the driver to stop the towing vehicle immediately. The hitch ball 18 is now aligned under the trailer socket 14. The driver puts the towing vehicle in “Park”, and exits the vehicle. The driver then lowers the trailer socket 14 onto the hitch ball 18 and engages the trailer latching clip 63 (see FIG. 1), as usual.

Also included herein is a kit for aligning a trailer hitch 19 of a towing vehicle 25 with a corresponding socket 14 on a trailer. The kit comprises:
(a) a trailer vertical rod assembly 12 mountable on the trailer, the trailer vertical rod assembly 12 comprising a vertically extendible rod 12A;
(b) a stop 13 mountable on the trailer hitch 19;
(c) a rear view mirror line tab 23 attachable to a rear view mirror 24 of the towing vehicle 25; and
(d) a rear line tab 26 or 66 attachable to a rear window 27 or a tailgate 68, respectively, of the towing vehicle. The kit preferably further comprises a trunk vertical rod assembly 69 attachable to a trunk lid 72 of the towing vehicle 25 instead of, or in addition to, the rear line tab 26, 66.

From the foregoing it can be realized that the described system of the present invention may be easily and conveniently utilized as a trailer hitch alignment system. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Brief List of Reference Numbers Used in the Drawings

10 trailer hitch alignment system
11 receiver sleeve
12 trailer vertical rod assembly
12A rod
13 stop
13A alternate stop
14 socket of trailer
15 trailer tongue
16 top end of receiver sleeve
17 bottom end of receiver sleeve
18 hitch ball
19 trailer hitch
19A ball mount of trailer hitch
20 stop brace
20A alternate stop brace
21 stop plate
21A alternate stop plate
22 pin
23 rear view mirror line tab
24 rear view mirror
25 towing vehicle
26 rear line tab
27 rear window
28 driver
29 trailer
30 attachment assembly
31 jack
32 flange
33 inverted U-shaped section
33A L-shaped section
34 attachment arm
35 horizontal portion hole
36 first nut
37 first rivets
38 first holes
39 bolts
40 second holes
41 threaded end
42 second nut
43 horizontal portion
44 vertical portion
45 fourth hole
46 fifth hole
47 linear section
48 curved section
49 rear side of stop plate
50 front side of stop plate
51 first end
52 second end
53 longitudinal axis of vehicle
54 first transparent sheet
55 rear view mirror frame
56 second transparent sheet
57 bumper
58 lower rod segment
59 middle rod segment
60 upper rod segment
61 ball
62 permanent magnet
63 trailer latching clip
64 suction cups
65 rear mirror adjuster switch
66 tailgate line tab
67 front face
68 tailgate
69 trunk vertical rod assembly
70 second rod
71 base
72 trunk lid
73 U-shaped section
74 matching arms
75 receiver sleeve hole
76 sixth holes
77 second rivets
78 first, bottom end
79 second, bottom end
80 alternative receiver sleeve attachment assembly
81 horizontal section
82 third ends
83 fourth ends

1. A system for aligning a trailer hitch ball of a towing vehicle with a corresponding socket on a trailer, the alignment system comprising:
(a) a trailer vertical rod assembly mountable on the trailer, the trailer vertical rod assembly comprising a rod that extends in a vertical direction, the rod being mountable over the trailer socket;
(b) a stop mountable on a ball mount of the trailer hitch of the towing vehicle;
(c) a rear mirror line tab attachable to a rear view mirror of the towing vehicle; and
(d) a rear line tab attachable to a rear window or a tailgate of the towing vehicle.

2. The alignment system according to claim 1, wherein the trailer vertical rod assembly comprises:
(a) a hollow receiver sleeve having an aperture at an upper end; and
(b) a detachable pin for securing the rod within the receiver sleeve;
wherein the rod is removably insertable through the receiver sleeve aperture into a hollow of the receiver sleeve.

3. The alignment system according to claim 1, wherein one end of the rod is affixed to a center of a top surface of the trailer socket.

4. The alignment system according to claim 1, wherein the stop is mounted on a ball mount of the trailer hitch between the stop and a rear end of the towing vehicle, an upper portion of the stop extending vertically above the level of a hitch ball of the trailer hitch.

5. The alignment system according to claim 2, wherein the stop comprises a stop plate having a height that is greater than the height of the hitch ball, a face of the stop plate being parallel to a bumper of the towing vehicle.

6. The alignment system according to claim 5, wherein the stop further comprises a stop brace, the stop plate comprises a rear side facing the trailer hitch ball, and a front side opposite the rear side, the stop brace being generally triangular in shape and attached to the front side of the stop plate.

7. The alignment system according to claim 1, wherein the rear mirror line tab is oriented vertically on a center of the rear view mirror, and the rear line tab is oriented vertically on a center of the rear window of the towing vehicle.

8. The alignment system according to claim 1, wherein a bottom face of the rear mirror line tab and a bottom face of the rear line tab comprise an adhesive, and the line tabs are removable.

9. The alignment system according to claim 6, wherein at least one suction cup is attached to the rear line tab.

10. The alignment system according to claim 2, wherein the rear mirror line tab is incorporated into a transparent, first plastic sheet, and the rear line tab is incorporated into a transparent, second plastic sheet, the first plastic sheet being removably insertable in and attachable to the rear view mirror, and the second plastic sheet being insertable in and removably attachable to the rear window or tailgate.

11. The alignment system according to claim 2, wherein the receiver sleeve is mounted on a top side of the trailer socket at the center of the socket, so that the receiver sleeve extends upward in a generally vertical direction.

12. The alignment system according to claim 2, wherein a permanent magnet removably attaches the receiver sleeve to the trailer socket.

13. The alignment system according to claim 6, wherein the stop is permanently attached to a ball mount of the trailer hitch.

14. The alignment system according to claim 2, further comprising a receiver sleeve attachment assembly comprising an L-shaped section and an attachment arm, the L-shaped section comprising a horizontal portion and a vertical portion, the vertical portion of the L-shaped section being attached to a first end of the attachment arm, a second, opposite end of the attachment arm being attachable to a tongue of the trailer.

15. The alignment system according to claim 2, further comprising a receiver sleeve attachment assembly comprising an inverted U-shaped section and matching arms for attaching the inverted U-shaped section to the trailer, the inverted U-shaped section comprising a substantially horizontal section, a first, bottom end, and a second, bottom end, and the matching arms comprising third ends being attached to the first, bottom end and the second, bottom end of the inverted U-shaped section and fourth ends being attachable to a tongue of the trailer.

16. The alignment system according to claim 15, wherein the horizontal section of the inverted U-shaped section comprises a generally circular, threaded, receiver sleeve hole and the receiver sleeve comprises a correspondingly threaded end insertable in the receiver sleeve hole.

17. The alignment system according to claim 1, wherein the trailer vertical rod assembly further comprises a U-shaped pin, the U-shaped pin comprising a linear pin section and an opposite, curved pin section, the linear pin section being insertable through a generally circular, fourth hole extending transversely through the receiver sleeve and a generally circular, fifth hole extending transversely through the rod, the curved pin section contacting the receiver sleeve.

18. The alignment system according to claim 1, wherein the rod is telescoping and pivotable.

19. The alignment system according to claim 1, wherein the rear mirror line tab is attachable to a rear mirror adjuster switch.

20. A system for aligning a trailer hitch of a towing vehicle with a corresponding socket on a trailer, the alignment system comprising:
(a) a trailer vertical rod assembly mountable on the trailer, the trailer vertical rod assembly comprising a rod that extends in a vertical direction;
(b) a stop mountable on the trailer hitch;
(c) a rear mirror line tab attachable to a rear view mirror of the towing vehicle; and
(d) a tailgate line tab attachable to a front face of a tailgate of the towing vehicle.

21. A system for aligning a trailer hitch of a towing vehicle with a corresponding socket on a trailer, the alignment system comprising:
(a) a trailer vertical rod assembly mountable on the trailer, the trailer vertical rod assembly comprising a vertically extendible rod;
(b) a stop mountable on a ball mount of the trailer hitch;
(c) a rear mirror line tab attachable to a rear view mirror of the towing vehicle; and
(d) a trunk vertical rod assembly attachable to a trunk lid of the towing vehicle; wherein the stop is not a bumper of the towing vehicle and the system does not comprise any pole extending up in a vertical direction from the trailer hitch.

22. A kit for aligning a trailer hitch of a towing vehicle with a corresponding socket on a trailer, the kit comprising:
(a) a trailer vertical rod assembly mountable on the trailer, the trailer vertical rod assembly comprising a vertically extendible rod;
(b) a stop mountable on the trailer hitch; and
(c) a rear view mirror line tab attachable to a rear view mirror of the towing vehicle.

23. The kit according to claim 22, further comprising a trunk vertical rod assembly attachable to a trunk lid of the towing vehicle.
